(19) United States
(12) Patent Application Publication
(10) Pub. No.: US 2022/0341785 A1
(43) Pub. Date: Oct. 27, 2022

(54) SPECTRUM MEASUREMENT DEVICE

(71) Applicant: NEC Corporation, Minato-ku, Tokyo (JP)

(72) Inventor: Takeshi AKAGAWA, Tokyo (JP)

(73) Assignee: NEC Corporation, Minato-ku, Tokyo (JP)

(21) Appl. No.: 17/760,831

(22) PCT Filed: Sep. 26, 2019
(86) PCT No.: PCT/JP2019/037813

§ 371 Date: Mar. 16, 2022

(51) Int. Cl. G01J 3/453; G01J 3/30

(52) U.S. Cl. CPC G01J 3/4535; G01J 3/30; G01J 2003/452

(57) ABSTRACT

A spectrum measurement device of the present invention includes a spectroscope configured to output a first measurement result that is a result of measuring characteristics of light from an object to be measured, an optical monitor configured to output a second measurement result that is a result of measuring intensity of light from the object to be measured, and a control circuit configured to correct the first measurement result, based on the second measurement result and output a third measurement result, based on the corrected first measurement result.

### TECHNICAL FIELD

The present invention relates to a spectrum measurement device.

### BACKGROUND ART

As devices for measuring a spectrum of light that an object to be measured emits, spectroscopic devices using a hyperspectral camera or a Michelson interferometer have been known. A hyperspectral camera spectrally disperses an image captured by one-dimensionally imaging an object to be measured, by a grating and, at the same time, scans an imaging area thereof on the object to be measured. This configuration enables a spectrum of a two-dimensional image of the object to be measured to be acquired. In PTLs 1 to 3, spectroscopic devices using a Michelson interferometer are described. A Michelson interferometer is capable of measuring a spectrum of light incident on a spectroscopic device with high wavelength resolution. In particular, in PTLs 2 and 3, Fourier transform infrared spectrometers (FTIR) configured by a Michelson interferometer are described. In PTL 4, a Fourier interferometric spectroscope including an intensity monitoring unit is described.

### CITATION LIST

### Patent Literature

[PTL 1] Japanese Unexamined Patent Application Publication No. H07-012648 A

[PTL 2] Japanese Unexamined Patent Application Publication No. H10-009957 A

[PTL 3] Japanese Unexamined Patent Application Publication No. 2006-300664 A

[PTL 4] Japanese Unexamined Patent Application Publication No. 2015-064228 A

### SUMMARY OF INVENTION

### Technical Problem

There has been a problem in that, when a temporal variation (fluctuation) is included in intensity of light (incident light) incident from an object to be measured, a general spectrum measurement device cannot measure an accurate spectrum. The reason for the problem is that, when intensity of incident light varies during measurement of a spectrum, error occurs in relative intensity between wavelengths of a spectrum measured by a spectroscope.

An object of the present invention is to provide a technology capable of reducing measurement error in a spectrum of incident light when intensity of incident light temporally fluctuates.

### Solution to Problem

A spectrum measurement device of the present invention includes a spectroscopic means for outputting a first measurement result that is a result of measuring characteristics of light from an object to be measured, an optical monitoring means for outputting a second measurement result that is a result of measuring intensity fluctuation of light from the object to be measured, and a control means for correcting the first measurement result, based on the second measurement result and outputting a third measurement result, based on the corrected first measurement result.

A spectrum measurement method of the present invention includes the processes of outputting a first measurement result that is a result of measuring characteristics of light from an object to be measured, outputting a second measurement result that is a result of measuring intensity of light from the object to be measured, correcting the first measurement result, based on the second measurement result, and outputting a third measurement result, based on the corrected first measurement result.

### Advantageous Effects of Invention

A spectrum measurement device of the present invention is capable of reducing measurement error in a spectrum in the case where intensity of incident light temporally fluctuates.

### BRIEF DESCRIPTION OF DRAWINGS

FIG. 1 is a diagram illustrating a configuration example of a spectrum measurement system 10 of a first example embodiment;

FIG. 2 is a block diagram illustrating a configuration example of a spectrum measurement device 100;

FIG. 3 is a diagram illustrating a configuration example of a spectroscope 110;

FIG. 4 is a diagram describing acquisition of a spectrum from an interferogram;

FIG. 5 is a diagram describing correction of intensity of an interferogram output by the spectroscope 110;

FIG. 6 is a flowchart illustrating an example of an operation process of the spectrum measurement device 100;

FIG. 7 is a block diagram illustrating a configuration example of a spectrum measurement device 200 of a second example embodiment;

FIG. 8 is a diagram illustrating a configuration example of a two-dimensional spectroscope 210;

FIG. 9 is a diagram illustrating an example of spatial resolution of respective light receiving surfaces of a two-dimensional optical detector 214 and an optical monitor 220;

FIG. 10 is a diagram illustrating another example of the spatial resolution of the respective light receiving surfaces of the two- dimensional optical detector 214 and the optical monitor 220;

FIG. 11 is a flowchart illustrating an example of an operation process of the spectrum measurement device 200;

FIG. 12 is a diagram describing an example of influence of

Rayleigh scattering in a third example embodiment; and

FIG. 13 is a block diagram illustrating a configuration example of a spectrum measurement device 100 of a fourth example embodiment.

### EXAMPLE EMBODIMENT

Embodiments of the present invention will be described below. In the drawings of the embodiments, arrows indicating directions in which light, electrical signals, or information is transmitted are examples and do not intend to limit the directions thereof.

### First Example Embodiment

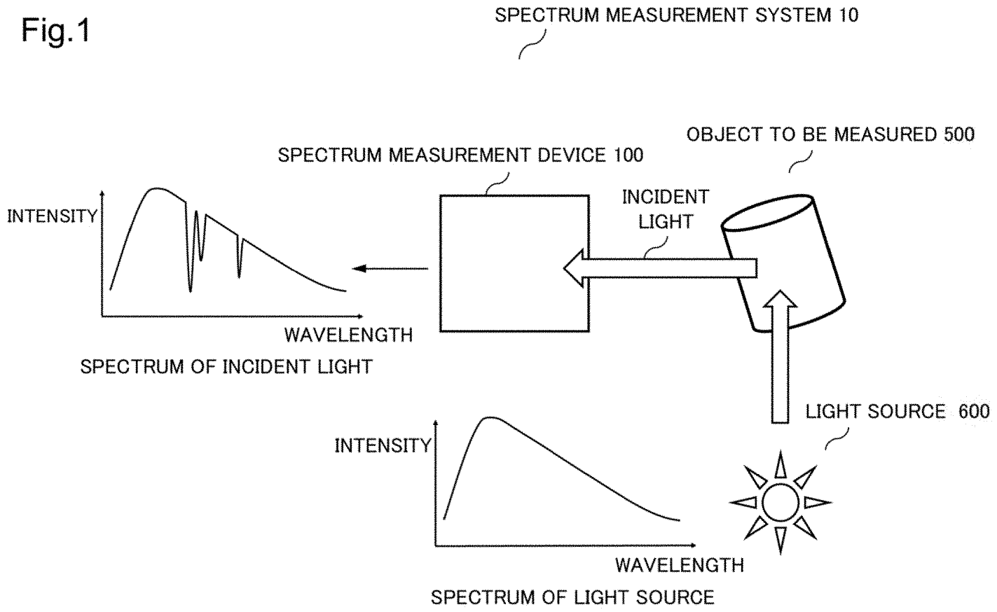

FIG. 1 is a diagram illustrating a configuration example of a spectrum measurement system 10 of a first example embodiment of the present invention. Light emitted by a light source 600 is reflected by an object 500 to be measured. The reflected light is incident on a spectrum measurement device 100. Hereinafter, light incident on the spectrum measurement device 100 from an object to be measured and light split from the light are referred to as incident light.

The spectrum measurement device 100 measures a spectrum of incident light (that is, wavelength characteristics of intensity of incident light) and outputs a result of the measurement. An object to be measured is, for example, a person, a plant or animal, a photograph, a picture, or a construction. The shape and properties of an object to be measured are not specifically limited, and gas, liquid, solid, or a mixture thereof (including plasma and flame) may be targeted as an object to be measured. The spectrum measurement device 100 may directly measure light emitted by a light emitter as incident light. Incident light may be light transmitted through the object 500 to be measured.

Since a spectrum of incident light has characteristics matching an object to be measured and measurement conditions, measuring a spectrum of the incident light enables physical properties of the object to be measured to be estimated. The light source 600 is generally a white light source. However, there are cases where the light source 600 has different spectra depending on the measurement environment.

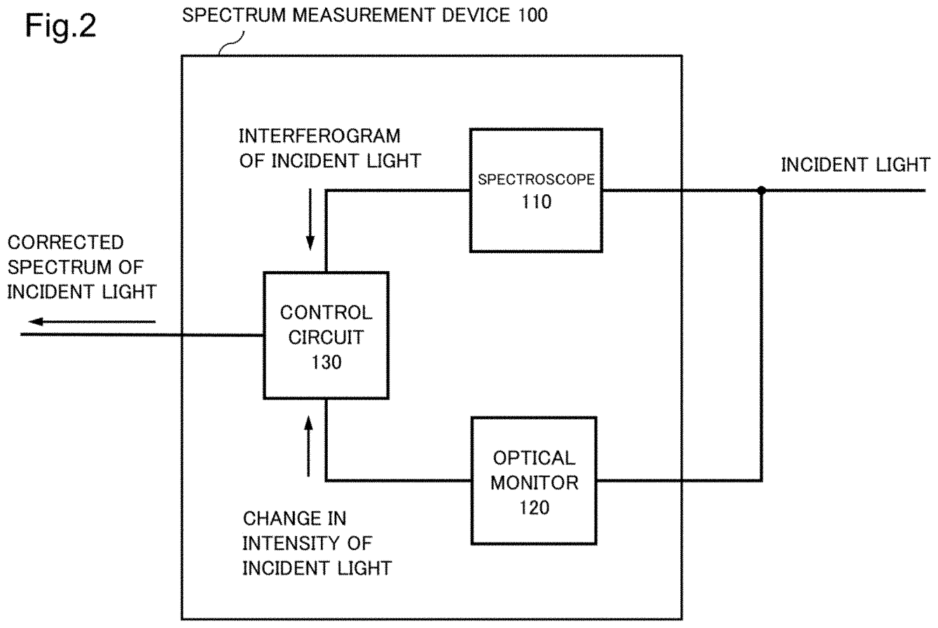

FIG. 2 is a block diagram illustrating a configuration example of the spectrum measurement device 100 used in the spectrum measurement system 10. The spectrum measurement device 100 includes a spectroscope 110, an optical monitor 120, and a control circuit 130. The spectroscope 110 outputs an interferogram that is a result of measuring characteristics of incident light to the control circuit 130 as a first measurement result. The interferogram is data containing information of a spectrum of incident light, and details of the interferogram will be described later.

On the optical monitor 120, light having intensity proportional to the intensity of incident light is incident. The optical monitor 120 is a photoelectric conversion circuit and outputs an electrical signal having amplitude (for example, voltage amplitude) proportional to the intensity of light input to the circuit to the control circuit 130 as a second measurement result. The optical monitor 120 includes, for example, a photodiode and a current-voltage conversion circuit. Therefore, the amplitude of an electrical signal that the optical monitor 120 outputs to the control circuit 130 is proportional to the intensity of incident light. In other words, the optical monitor 120 is capable of notifying the control circuit 130 of the second measurement result, which is a result of measuring intensity fluctuation of incident light incident on the spectrum measurement device 100. A method for generating light to be incident on the optical monitor 120 is not limited to a specific method. The spectrum measurement system 10 may split incident light, using an optical coupler and distribute split incident light beams to the spectroscope 110 and the optical monitor 120.

The control circuit 130 corrects the first measurement result output by the spectroscope 110, based on the second measurement result output by the optical monitor 120. The control circuit 130 generates a signal indicating a spectrum of incident light according to the corrected first measurement result and outputs the signal to the outside of the spectrum measurement device 100 as a third measurement result. An external device (for example, a display device) may display the spectrum on a screen, using the signal output from the spectrum measurement device 100. In the present example embodiment, the first measurement result, the second measurement result, and the third measurement result are an interferogram of incident light, intensity fluctuation of the incident light, and a spectrum of the incident light, respectively.

The spectrum measurement device 100 having the configuration described above, by correcting a measurement result of the spectroscope 110, based on the intensity of incident light measured by the optical monitor 120, is capable of correcting intensity fluctuation of the incident light contained in the measurement result of the spectroscope 110. As a result of this capability, the spectrum measurement device 100 is capable of reducing measurement error of the spectrum of incident light and measuring the spectrum of the incident light more accurately.

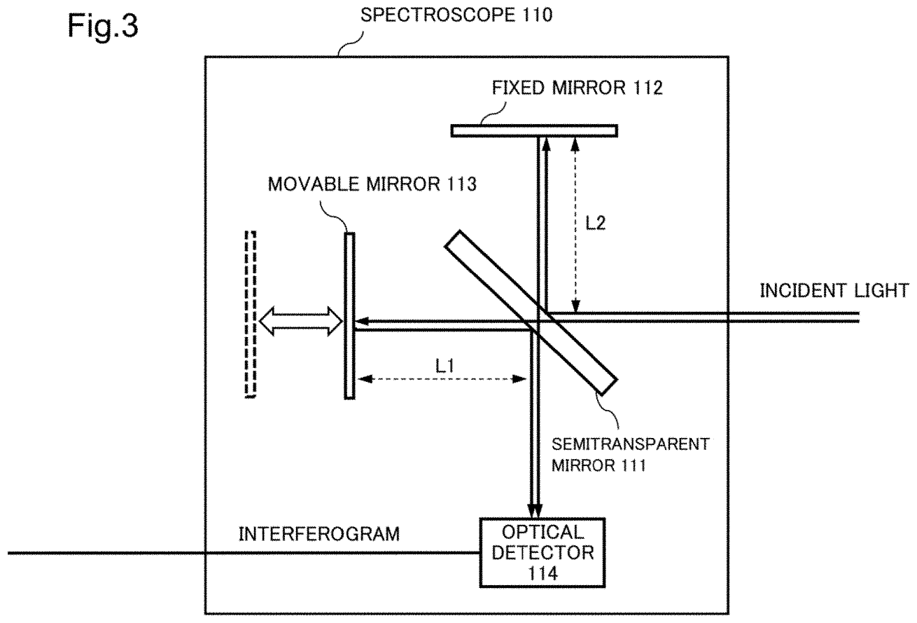

FIG. 3 is a diagram illustrating a configuration example of the spectroscope 110. In the present example embodiment, the spectroscope 110 is a Michelson interferometer. Since a general technology for measuring a spectrum of incident light, using a Michelson interferometer has been known, a known configuration and process will be briefly described in the following description.

The Michelson interferometer includes a semitransparent mirror 111, a fixed mirror 112, a movable mirror 113, and an optical detector 114. In FIG. 3, an illustration of an optical system for image formation, such as a lens, is omitted. The Michelson interferometer, by moving the movable mirror 113 in a perpendicular position to the optical axis, sweeps wavelength of an incident light beam to be combined with an incident light beam reflected by the fixed mirror 112 at the semitransparent mirror 111. The control circuit 130 may control a movement amount of the movable mirror 113. The spectroscope 110 outputs an electrical signal indicating intensity of light that is generated by an incident light beam reflected by the fixed mirror 112 and an incident light beam reflected by the movable mirror 113 interfering with each other, from the optical detector 114. The electrical signal that the optical detector 114 outputs correspond to the above-described first measurement result (interferogram) and is supplied to the control circuit 130 in FIG. 2.

The electrical signal that the optical detector 114 outputs can be represented as a waveform drawn with optical path difference [(L1-L2)×2] between the fixed mirror 112 and the movable mirror 113 as the abscissa and intensity at the optical path difference as the ordinate. This waveform is referred to as an interferogram. In other words, the optical detector 114 outputs the interferogram of incident light to the control circuit 130 as an electrical signal. The interferogram has wavelength characteristics of incident light in the Michelson interferometer. PTLs 2 and 3 also describe technologies for measuring an interferogram of incident light, using a Michelson interferometer.

All of the waveforms of interferograms and spectra illustrated in the drawings herein are examples and indicate neither actual waveforms nor actual relationships between interferograms and spectra.

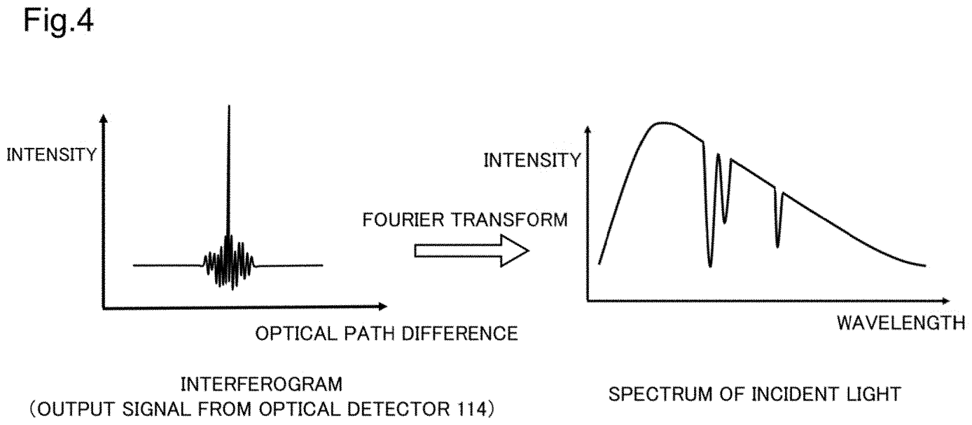

FIG. 4 is a diagram describing acquisition of a spectrum from an interferogram. Light combined at the semitransparent mirror 111 (interference light) is input to the optical detector 114. The optical detector 114 outputs an electrical signal having amplitude proportional to intensity of the interference light. The output signal is an interferogram and is exemplified on the left side of FIG. 4. The abscissa of the interferogram represents an optical path difference between light beams that interfere with each other at the interferometer. When the movable mirror 113 is moved in the direction of the optical axis at a constant velocity, the optical path difference represented by the abscissa is easily converted to measurement time. In this case, the ordinate of the interferogram represents intensity of interference light at a measurement time. The control circuit 130 Fourier transforming the interferogram enables a spectrum of incident light with the abscissa representing the wavelength of the incident light and the ordinate representing the intensity of the incident light to be acquired. A spectrum of incident light is exemplified on the right side of FIG. 4.

Functions of the control circuit 130 may be achieved by hardware. Alternatively, the control circuit 130 may include a central processing unit (CPU) and a storage device, and functions of the spectrum measurement device 100 may be achieved by the CPU executing a program stored in the storage device.

When the intensity of incident light temporally fluctuates at the time of measuring an interferogram of the incident light while moving the movable mirror 113 in the spectroscope 110, the intensity of interference light represented by the ordinate of the interferogram also fluctuates. For example, when transmittance of the air outside the spectrum measurement device 100 fluctuates, the intensity of incident light incident on the spectrum measurement device 100 also fluctuates. Therefore, in order to acquire an accurate interferogram of incident light, using the spectrum measurement device 100, the spectrum measurement device 100 is preferably capable of correcting temporal fluctuation of the intensity of the incident light during movement of the movable mirror 113.

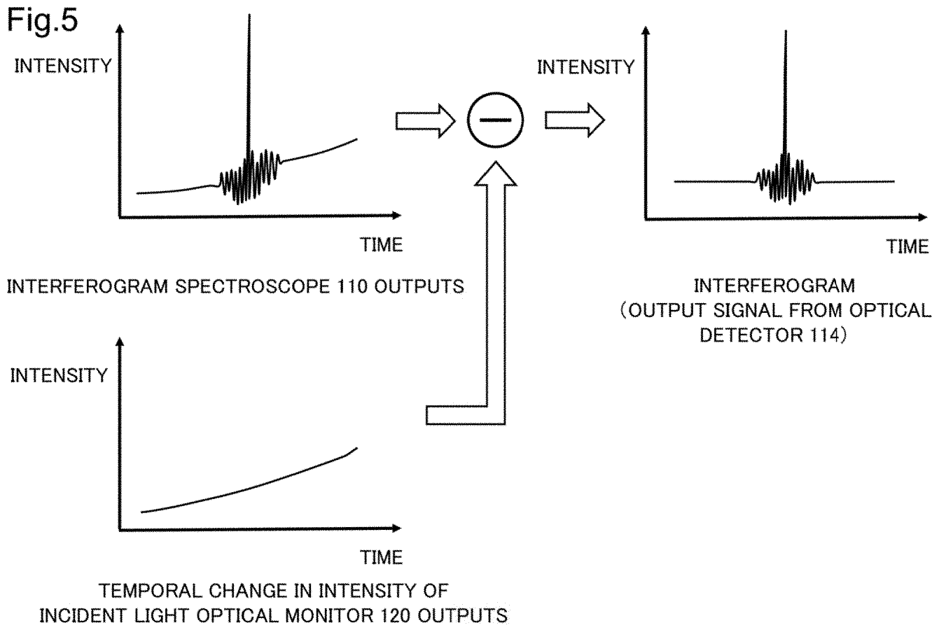

FIG. 5 is a diagram describing correction of intensity of an interferogram output by the spectroscope 110. The optical monitor 120 measures temporal fluctuation of intensity of incident light in parallel with measurement of an interferogram by the spectroscope 110 and notifies the control circuit 130 of a measurement result. In order to guide a portion of incident light to the optical monitor 120, a beam splitter can be used.

The control circuit 130 outputs a spectrum of incident light the intensity fluctuation of which is corrected based on a result of measurement by the optical monitor 120. For example, the control circuit 130, by normalizing the intensity of incident light detected by the optical monitor 120 in parallel with measurement of an interferogram with the maximum value of the intensity of the incident light during a measurement period, calculates a fluctuation rate of the intensity of the incident light at each time. The control circuit 130 corrects an intensity of the interferogram input from the spectroscope 110 with a fluctuation rate at an identical time.

Specifically, when the intensity of incident light is X (0<X≤1) times the maximum value at a time T, the control circuit 130 corrects the intensity of the interferogram at the time T to a value 1/X times the original value. In other words, the correction is performed in such a way that the intensity of incident light input to the optical detector 114 at the time T becomes 1/X times the actual value. In this way, the control circuit 130 corrects temporal fluctuation of the intensity of an interferogram output by the spectroscope 110. As a result, the control circuit 130 is capable of Fourier transforming the interferogram the intensity of which is corrected and thereby calculating a spectrum of incident light.

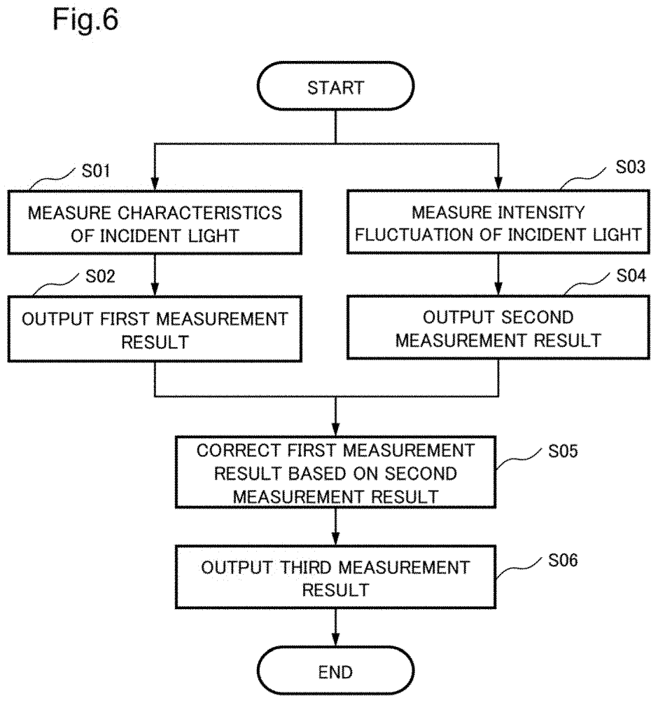

FIG. 6 is a flowchart illustrating an example of an operation process of the spectrum measurement device 100. The spectroscope 110 measures characteristics of incident light (step S01 in FIG. 6) and outputs a result of the measurement to the control circuit 130 as a first measurement result (interferogram) (step S02). The optical monitor 120 measures intensity fluctuation of the incident light (step S03) and outputs a result of the measurement to the control circuit 130 as a second measurement result (step S04). The control circuit 130 corrects the first measurement result, based on the second measurement result (step S05) and outputs a third measurement result according to the corrected first measurement result (step S06).

The measurement of characteristics of the incident light in step S01 and the measurement of intensity of the incident light in step S03 are performed in parallel at the same time. The first measurement result (interferogram) and the second measurement result (intensity of the incident light) are generated in such a way that the first measurement result can be associated with the second measurement result at any time during measurement (that is, during movement of the movable mirror 113). This configuration enables normalization of the intensity of the incident light during a measurement period.

In steps S05 and S06, the control circuit 130 outputs a spectrum of the incident light calculated according to the corrected first measurement result, the corrected first measurement result being corrected based on the second measurement result. In other words, the control circuit 130 corrects the interferogram, based on the intensity fluctuation of the incident light (step S05) and outputs a spectrum acquired by Fourier transforming the corrected interferogram as a third measurement result.

### Second Example Embodiment

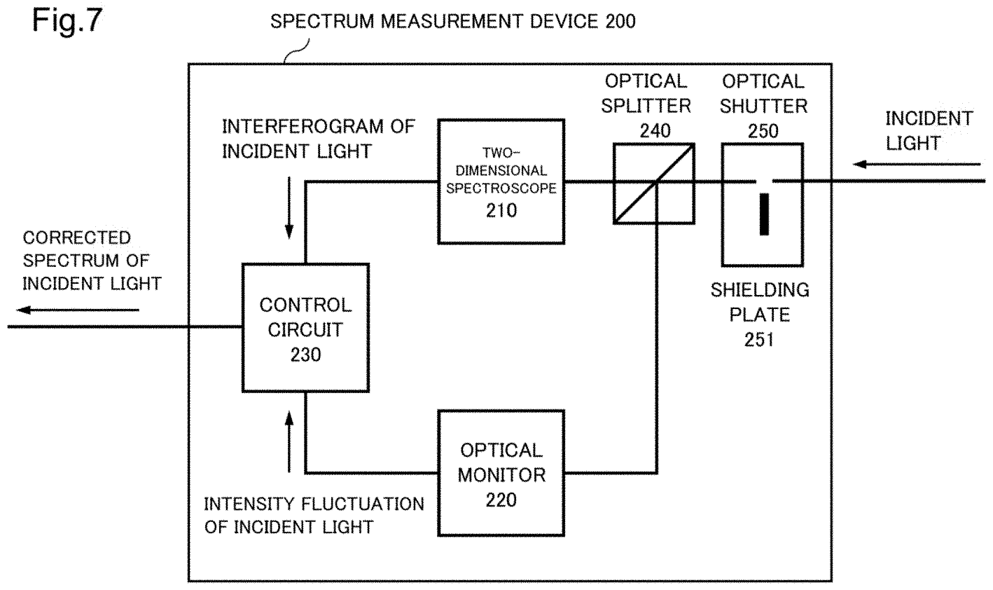

FIG. 7 is a block diagram illustrating a configuration example of a spectrum measurement device 200 of a second example embodiment of the present invention. The spectrum measurement device 200 includes a two-dimensional spectroscope 210, an optical monitor 220, a control circuit 230, an optical splitter 240, and an optical shutter 250. The spectrum measurement device 200, as with the first example embodiment, outputs a spectrum of incident light incident from an object 500 to be measured.

The optical shutter 250 controls incidence of incident light on the spectrum measurement device 200. The optical shutter 250, for example, moves a shielding plate 251 by driving a mechanism (for example, an electromagnet) with which the optical shutter 250 is provided in accordance with an instruction from the control circuit 230 and thereby transmits or cuts off incident light.

FIG. 7 illustrates a case where the optical shutter 250 is in an open state. When the optical shutter 250 is in the open state (that is, a state where incident light incident on the spectrum measurement device 200 is transmitted through the optical shutter 250), the incident light is incident on the optical splitter 240. When the optical shutter 250 is in a closed state (that is, a state where incident light incident on the spectrum measurement device 200 is cut off by the shielding plate 251), the incident light is not incident on the optical splitter 240. Bringing the optical shutter 250 to the open state enables the spectrum measurement device 200 to measure incident light. An optical switch that controls connection of incident light to the optical splitter 240 may be used in place of the optical shutter.

The optical splitter 240 is a beam splitter and splits incident light incident on the spectrum measurement device 200 to the two-dimensional spectroscope 210 and the optical monitor 220. The beam splitter splits the incident light to the two-dimensional spectroscope 210 and the optical monitor 220 at a predetermined split ratio. The split ratio is selected based on specifications of the two-dimensional spectroscope 210 and the optical monitor 220 in such a way that the spectrum measurement device 200 suitably operates. For example, the split ratio may be selected in such a way that more intense incident light is incident on the two-dimensional spectroscope 210 within a range that allows the optical monitor 220 to detect intensity fluctuation of the incident light. As the beam splitter, a dielectric multilayer film that splits 1% to 20% of incident light to a direction toward the optical monitor 220 and transmits 80% to 99% of the incident light to a direction toward the two-dimensional spectroscope 220 may be used.

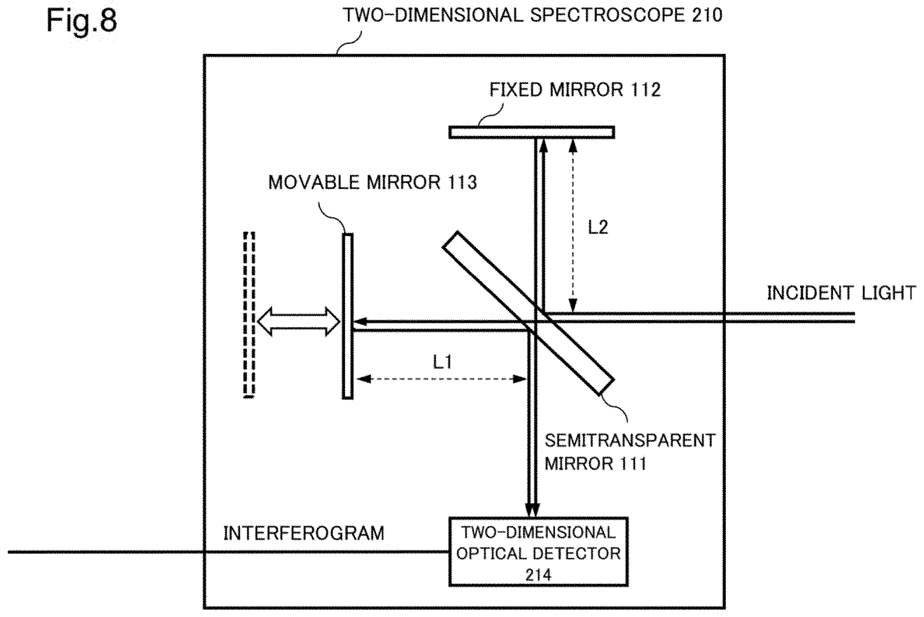

FIG. 8 is a diagram illustrating a configuration example of the two-dimensional spectroscope 210. In the present example embodiment, an example in which a two-dimensional Fourier spectroscope is used as the two-dimensional spectroscope 210 will be described. The two-dimensional spectroscope 210 outputs a two-dimensional distribution of interferograms of incident light that is calculated based on the incident light incident on the two-dimensional spectroscope 210. The two-dimensional spectroscope 210 basically outputs interferograms of the incident light, based on a similar principle to that of the spectroscope 110 in the first example embodiment. However, the two-dimensional spectroscope 210 differs from the spectroscope 110 in that the two-dimensional spectroscope 210 includes a two-dimensional optical detector 214 in place of the optical detector 114 of the spectroscope 110.

The two-dimensional spectroscope 210, as with the spectroscope 110, includes a semitransparent mirror 111, a fixed mirror 112, and a movable mirror 113. In FIG. 8, an illustration of an optical system for image formation, such as a lens, is omitted. The two-dimensional optical detector 214 is a two-dimensional image sensor having a plurality of pixels and outputs an electrical signal indicating brightness (that is, light intensity) of light incident on the two-dimensional image sensor, with respect to each pixel. As the two-dimensional image sensor, for example, a charge coupled device (CCD) is used. In other words, the two-dimensional spectroscope 210 outputs an interferogram of incident light, which is a two-dimensional image, with respect to each pixel of the two-dimensional optical detector 214. Therefore, the two-dimensional spectroscope 210 is capable of calculating a two-dimensional distribution of interferograms of an image incident from an object to be measured.

The optical monitor 220 illustrated in FIG. 7 includes an optical detection circuit that converts a two-dimensional distribution of intensity of light incident on the spectrum measurement device 200 to an electrical signal. In other words, the optical monitor 220 measures a two-dimensional distribution of intensity of incident light split by the optical splitter 240. As the optical detection circuit, a two-dimensional image sensor, such as a CCD, can be used.

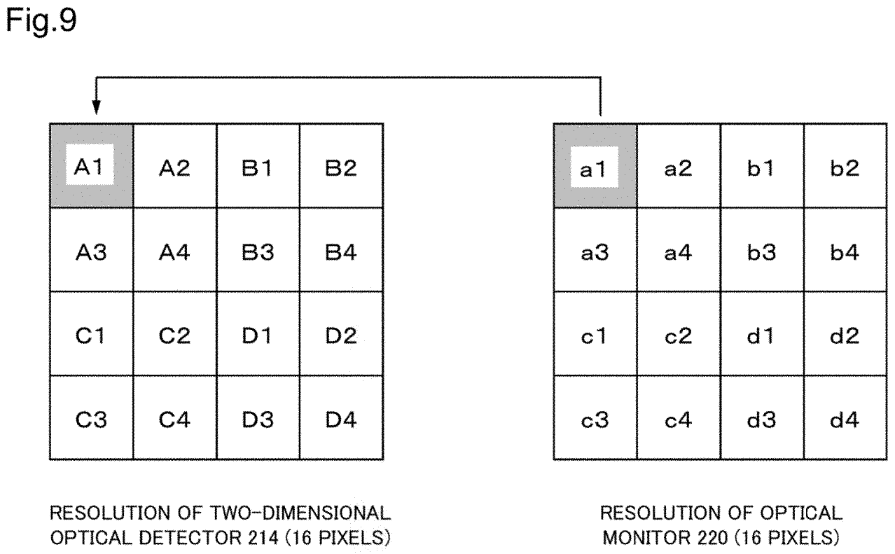

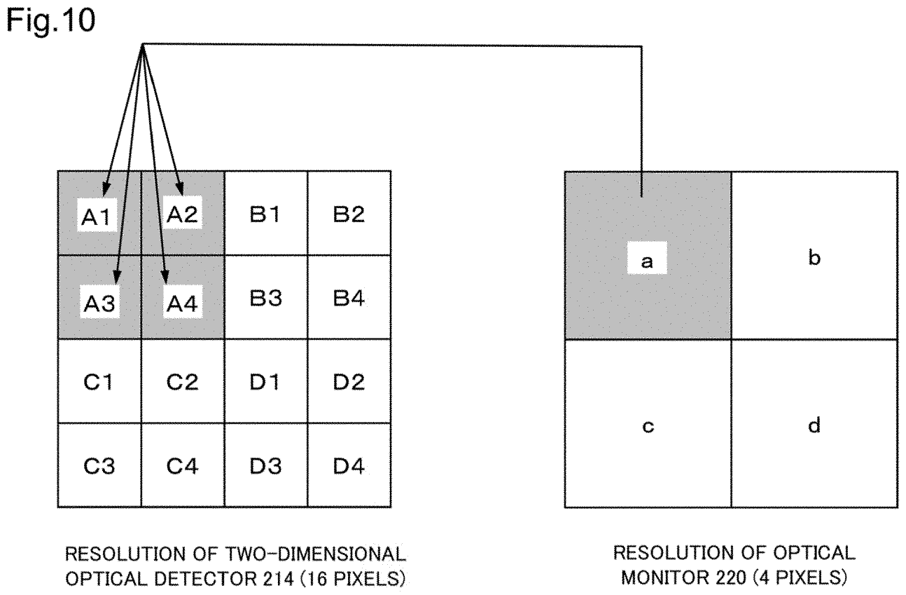

FIGS. 9 and 10 are diagrams illustrating examples of spatial resolution (hereinafter, simply referred to as “resolution”) of respective light receiving surfaces of the two-dimensional optical detector 214 and the optical monitor 220. The resolution of the two-dimensional spectroscope 210 is defined by the resolution of the two-dimensional optical detector 214. FIG. 9 illustrates an example in which both the two-dimensional optical detector 214 and the optical monitor 220 have a resolution of 16 pixels, and FIG. 10 illustrates an example in which the two-dimensional optical detector 214 has a resolution of 16 pixels and the optical monitor 220 has a resolution of 4 pixels. In FIGS. 9 and 10, area (that is, the sum of areas of pixels) of the light receiving surface of the two-dimensional optical detector 214 and area of the light receiving surface of the optical monitor 220 are equal to each other. Incident light forms images of the same size on the respective light receiving surfaces of the two-dimensional optical detector 214 and the optical monitor 220

In FIG. 9, all the areas of the pixels (A1 to A4, B1 to B4, C1 to C4, and D1 to D4) of the two-dimensional optical detector 214 and the pixels (a1 to a4, b1 to b4, c1 to c4, and d1 to d4) of the optical monitor 220 are the same. In FIG. 10, the areas of the pixels (A1 to A4, B1 to B4, C1 to C4, and D1 to D4) of the two-dimensional optical detector 214 are the same, and each of the areas of pixels a to d of the optical monitor 220 is four times the area of the pixel Al of the two-dimensional optical detector.

Referring to FIG. 9, the two-dimensional optical detector 214 has 16 pixels, namely the pixels A1 to A4, B1 to B4, C1 to C4, and D1 to D4, and the optical monitor 220 has 16 pixels, namely the pixels a1 to a4, b1 to b4, c1 to c4, and d1 to d4. Such a configuration enables the control circuit 130 to correct incident light intensity indicated by an interferogram with respect to each pixel of the two-dimensional optical detector 214. For example, the control circuit 130 is capable of correcting intensity of an interferogram detected at the pixel Al of the two-dimensional optical detector according to a correction amount calculated from incident light intensity detected at the pixel al of the optical monitor 220 at an identical time.

FIG. 10 illustrates an example of a case where the resolution of the optical monitor 220 is lower than the resolution of the two-dimensional optical detector 214. The resolution of the optical monitor 220 in measuring incident light intensity does not have to be the same as the resolution of the two-dimensional spectroscope 210 in generating an interferogram. For example, when a two-dimensional distribution of fluctuation of incident light intensity measured by the two-dimensional spectroscope 210 is considered to be smaller than a predetermined value, the resolution of the optical monitor 220 may be lower than the resolution of the two-dimensional spectroscope 210. Although the light receiving area of the optical monitor 220 illustrated in FIG. 10 is the same as the light receiving area of the two-dimensional optical detector 214, each of the areas of the pixels a to d is four times the area of the pixel A1. In this case, data of fluctuation of incident light intensity at a pixel (for example, the pixel a1 in FIG. 10) of the optical monitor 220 are used in a shared manner in correction of the incident light intensity at a plurality of pixels (for example, the pixels A1 to A4 in FIG. 9) of the two-dimensional spectroscope 210. Enlarging the area of each pixel of the optical monitor 220 causes light-receiving sensitivity of the optical monitor 220 to increase. Therefore, reducing power of an incident light beam of the incident light splitting to the optical monitor 220 side and increasing power of an incident light beam of the incident light splitting to the two-dimensional spectroscope 210, in the optical splitter 240 enable a signal-to-noise ratio of an interferogram to be improved. In FIG. 10, an example in which the optical monitor 220 has four pixels is illustrated. However, the number of pixels of the optical monitor 220 only has to be at least one and is not limited to four.

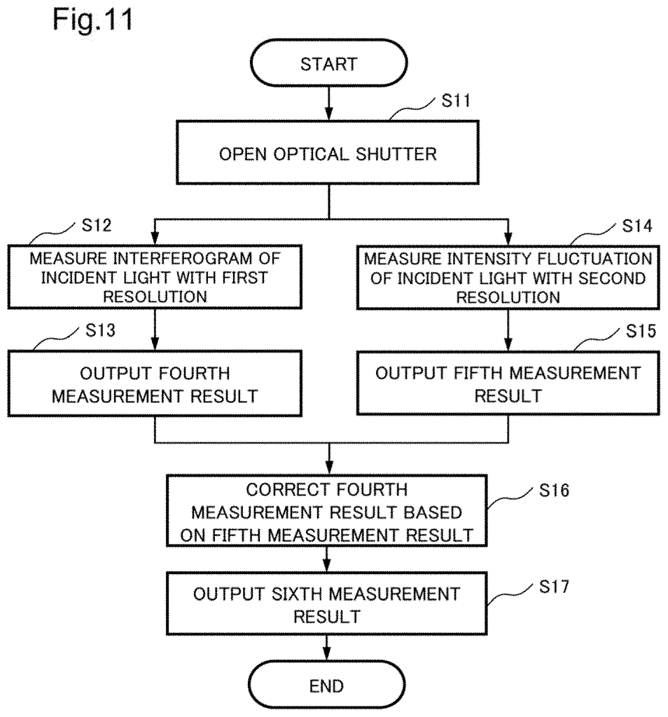

FIG. 11 is a flowchart illustrating an example of an operation process of the spectrum measurement device 200. Before measurement of a spectrum of incident light is started, the optical shutter 250 is closed and incident light is not incident on the optical splitter 240. Before the measurement, the control circuit 230 opens the optical shutter 250 (that is, brings the optical shutter 250 to the open state) (step S11 in FIG. 11). The two-dimensional spectroscope 210 measures a two-dimensional distribution of interferograms of incident light with first resolution (step S12) and outputs a result of the measurement (a fourth measurement result) to the control circuit 230 (step S13). The optical monitor 220 measures a two-dimensional distribution of intensity of the incident light from an object to be measured with second resolution (step S14) and outputs a result of the measurement (a fifth measurement result) to the control circuit 230 (step S15). The control circuit 230 corrects the fourth measurement result (that is, the interferograms), based on the fifth measurement result (step S16). The control circuit 230 outputs a two-dimensional distribution of spectra of the incident light acquired by Fourier transforming the corrected interferograms, as a sixth measurement result (step S17). The functions of the two-dimensional spectroscope 210, the optical monitor 220, and the control circuit 230 correspond to the functions of the spectroscope 110, the optical monitor 120, and the control circuit 130 of the first example embodiment, respectively.

The spectrum measurement device 200 having the configuration described above is also capable of reducing measurement error in spectra of incident light in the case where the intensity of the incident light temporally fluctuates. Further, since the spectrum measurement device 200 is capable of measuring a two-dimensional distribution of interferograms of incident light, the spectrum measurement device 200 is capable of calculating a two-dimensional distribution of spectra of an object to be measured.

### Variation of Second Example Embodiment

When both temporal fluctuation and spatial fluctuation of incident light intensity measured by the optical monitor 220 are smaller than a predetermined value, the control circuit 230 does not have to perform correction of interferograms using the amount of fluctuation detected by the optical monitor 220. Such a configuration enables error in measured values of spectra to be reduced and, at the same time, the amount of calculation in the control circuit 230 to be reduced.

### Third Example Embodiment

When a particle that is sufficiently small compared with wavelength of incident light exists between an object to be measured and a spectrum measurement device 200, incident light incident on the spectrum measurement device 200 is scattered by Rayleigh scattering caused by the particle. Intensity of Rayleigh scattering is inversely proportional to the fourth power of wavelength of light. For example, strong Rayleigh scattering sometimes occurs because of haze having small particle size. When light generated at the object to be measured is scattered by Rayleigh scattering, there is a possibility that spectral intensity in a short wavelength region of incident light incident on the spectrum measurement device 200 fluctuates and it becomes difficult to accurately measure a spectrum of the incident light.

The intensity of Rayleigh scattering with respect to incident light temporally fluctuates due to concentration and spatial distribution of particles in the atmosphere. In the present example embodiment, acquisition of an interferogram is performed a plurality of times over a period during which a plurality of peaks of the interferogram can be acquired. Then, a spectrum that is estimated to be least influenced by Rayleigh scattering is selected from among spectra of incident light acquired in the plurality of times of interferogram acquisition. This configuration enables a more accurate spectrum to be known even when incident light is transmitted through haze.

In other words, a control circuit 230 may select a spectrum to be output from among a plurality of spectra measured a plurality of times, based on spectral intensity in a predetermined wavelength range.

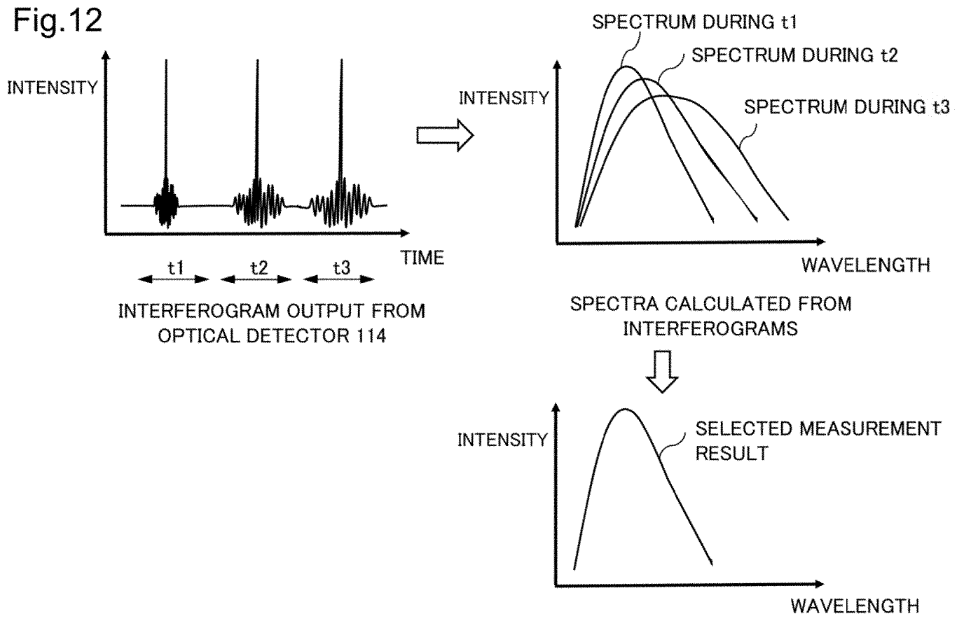

FIG. 12 is a diagram describing an example of influence of Rayleigh scattering. When influence of Rayleigh scattering is large, incident light of shorter wavelength is more strongly scattered. As a result, when incident light is strongly influenced by Rayleigh scattering, spectral intensity on the short wavelength side of incident light incident on the spectrum measurement device 200 is more significantly reduced. Therefore, it can be configured such that measurement of a spectrum is performed a plurality of times and a measurement result having the highest spectral intensity on the short wavelength side is selected as a result of measuring a spectrum of incident light. In FIG. 12, it is assumed that an interferogram is respectively measured during periods t1, t2, and t3 in each of which the interferogram has one of a plurality of peaks and, as a result of the measurement, three spectra having different peak wavelengths are acquired. When incident light is influenced by Rayleigh scattering, the spectrum of the incident light shifts to the long wavelength side because short wavelength components of the incident light are scattered. Therefore, it can be estimated that a spectrum containing the largest number of short wavelength components among the acquired spectra is a result of measuring a spectrum of incident light that is less influenced by the Rayleigh scattering. In other words, a spectrum containing the largest number of short wavelength side components may be selected as a result of measuring the spectrum of the incident light. Alternatively, a spectrum having a peak wavelength further on the short wavelength side may be selected as a result of measuring the spectrum of the incident light.

Alternatively, when properties of particles that cause Rayleigh scattering are known, a spectrum having a peak wavelength further on the short wavelength side within a wavelength range where scattering cross- section of scattering occurring between an object to be measured and the spectrum measurement device 200 is equal to or more than a predetermined value may be selected.

As described above, the spectrum measurement device 200, by selecting a measurement result having higher spectral intensity on the short wavelength side, further achieves an advantageous effect of being capable of selecting such a measurement result as a result of measuring a spectrum of incident light in which influence of Rayleigh scattering is reduced. The control circuit 230 may perform such selection and output a result of the selection.

Although, in the present example embodiment, the description was made using the spectrum measurement device 200 described in the second example embodiment as an example, a spectrum that is less influenced by Rayleigh scattering can also be selected through a similar process by the spectrum measurement device 100 described in the first example embodiment.

### Fourth Example Embodiment

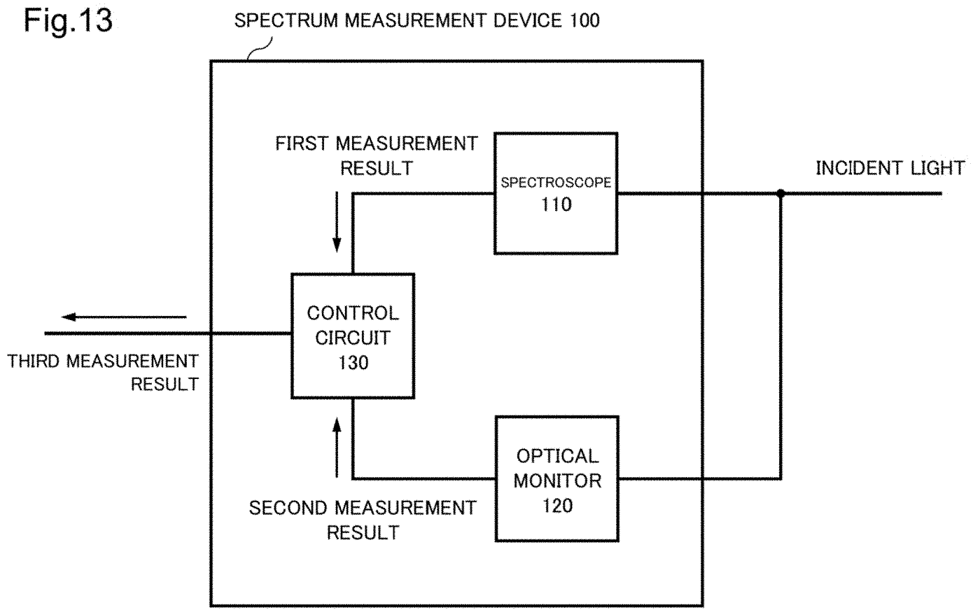

FIG. 13 is a block diagram illustrating a configuration example of a spectrum measurement device 100 of a fourth example embodiment. FIG. 13 is a diagram that illustrates the spectrum measurement device 100 described in the first example embodiment as the fourth example embodiment. In other words, the spectrum measurement device 100 of the fourth example embodiment includes a spectroscope 110, an optical monitor 120, and a control circuit 130.

The spectroscope 110 functions as a spectroscopic means for outputting a first measurement result that is a result of measuring characteristics of light (incident light) from an object to be measured. The optical monitor 120 functions as an optical monitoring means for outputting a second measurement result that is a result of measuring intensity fluctuation of the light from the object to be measured. The control circuit 130 functions as a control means for correcting the first measurement result based on the second measurement result, and outputting a third measurement result based on the corrected first measurement result.

The spectrum measurement device 100 corrects a result of measuring characteristics of incident light, based on a result of measuring intensity fluctuation of the incident light and outputs the third measurement result, based on a result of the correction. As a result, the spectrum measurement device 100 of the fourth example embodiment is capable of reducing measurement error in a spectrum of incident light when intensity of the incident light temporally fluctuates.

All or some of the example embodiments described above may be described as in the following Supplementary Notes, but the present invention is not limited thereto.

### Supplementary Note 1

A spectrum measurement device including:

a spectroscopic means for outputting a first measurement result that is a result of measuring characteristics of light from an object to be measured;

an optical monitoring means for outputting a second measurement result that is a result of measuring intensity fluctuation of light from the object to be measured; and

a control means for correcting the first measurement result, based on the second measurement result and outputting a third measurement result, based on the corrected first measurement result.

### Supplementary Note 2

The spectrum measurement device according to Supplementary Note 1, wherein

the control means normalizes intensity of light included in the first measurement result during a measurement period of the spectroscopic means, based on a maximum value of intensity of light from the object to be measured during the measurement period of the spectroscopic means.

### Supplementary Note 3

The spectrum measurement device according to Supplementary Note 1 or 2, wherein

the first measurement result includes an interferogram of light incident from the object to be measured, and

the third measurement result includes a spectrum calculated based on the second measurement result and the interferogram.

### Supplementary Note 4

The spectrum measurement device according to any one of Supplementary Notes 1 to 3, wherein

the first measurement result is a result of measurement measuring characteristics of light incident from the object to be measured with first spatial resolution, and

the second measurement result is a result of measurement measuring intensity of light incident from the object to be measured with second spatial resolution.

### Supplementary Note 5

The spectrum measurement device according to Supplementary Note 4, wherein

the first spatial resolution and the second spatial resolution are equal to each other.

### Supplementary Note 6

The spectrum measurement device according to Supplementary Note 4, wherein

the first spatial resolution is higher than the second spatial resolution.

### Supplementary Note 7

The spectrum measurement device according to any one of Supplementary Notes 1 to 6, wherein

the control means outputs the second measurement result as the third measurement result when fluctuation of the first measurement result during a predetermined period is within a predetermined fluctuation width.

### Supplementary Note 8

The spectrum measurement device according to any one of Supplementary Notes 1 to 7, wherein

the control means outputs, among a plurality of the third measurement results, the third measurement result selected from among the plurality of the third measurement results, based on spectral intensity in a predetermined wavelength range.

### Supplementary Note 9

The spectrum measurement device according to Supplementary Note 8, wherein

the predetermined wavelength range is a wavelength range on a short wavelength side within a wavelength range of the third measurement result.

### Supplementary Note 10

The spectrum measurement device according to Supplementary Note 8 or 9, wherein

the predetermined wavelength range is a wavelength range where scattering cross-section of scattering occurring between an object to be measured and the spectrum measurement device is equal to or more than a predetermined value.

### Supplementary Note 11

The spectrum measurement device according to any one of Supplementary Notes 1 to 10, wherein

the optical monitoring means is a photoelectric conversion device capable of two-dimensional imaging and the spectroscopic means is a two- dimensional Fourier spectroscope.

### Supplementary Note 12

The spectrum measurement device according to any one of Supplementary Notes 1 to 10, wherein

the optical monitoring means is a single-pixel photoelectric conversion device and the spectroscopic means is a two-dimensional Fourier spectroscope.

### Supplementary Note 13

The spectrum measurement device according to any one of Supplementary Notes 1 to 12, wherein

the optical monitoring means is connected to an output of an optical splitter that splits a portion of light from the object to be measured to the output at an intensity ratio of 1 percent or more and 20 percent or less.

### Supplementary Note 14

A spectrum measurement method including:

outputting a first measurement result that is a result of measuring characteristics of light from an object to be measured;

outputting a second measurement result that is a result of measuring intensity of light from the object to be measured;

correcting the first measurement result, based on the second measurement result; and

outputting a third measurement result, based on the corrected first measurement result.

### Supplementary Note 15

The spectrum measurement method according to Supplementary Note 14, wherein

the method normalizes intensity of light included in the first measurement result, based on a maximum value of intensity of light from the object to be measured.

### Supplementary Note 16

The spectrum measurement method according to Supplementary Note 14 or 15, wherein

the first measurement result includes an interferogram of light incident from the object to be measured, and

the third measurement result includes a spectrum calculated based on the second measurement result and the interferogram.

### Supplementary Note 17

The spectrum measurement method according to any one of Supplementary Notes 14 to 16, wherein

the first measurement result is a result of measurement measuring a spectrum of light from the object to be measured with first spatial resolution, and

the second measurement result is a result of measurement measuring intensity of light from the object to be measured with second spatial resolution.

### Supplementary Note 18

The spectrum measurement method according to Supplementary Note 17, wherein

the first spatial resolution and the second spatial resolution are equal to each other.

### Supplementary Note 19

The spectrum measurement method according to Supplementary Note 17, wherein

the first spatial resolution is higher than the second spatial resolution.

### Supplementary Note 20

The spectrum measurement method according to any one of Supplementary Notes 14 to 19, wherein

the method outputs the second measurement result as the third measurement result when fluctuation of the first measurement result during a predetermined period is within a predetermined fluctuation width.

### Supplementary Note 21

The spectrum measurement method according to any one of Supplementary Notes 14 to 20, wherein

the method outputs, among a plurality of the third measurement results, the third measurement result selected from among the plurality of the third measurement results, based on spectral intensity in a predetermined wavelength range.

### Supplementary Note 22

The spectrum measurement method according to Supplementary Note 21, wherein

the predetermined wavelength range is a wavelength range on a short wavelength side within a wavelength range of the third measurement result.

### Supplementary Note 23

The spectrum measurement method according to Supplementary Note 21 or 22, wherein

the predetermined wavelength range is a wavelength range where scattering cross-section of scattering occurring between an object to be measured and a position at which the spectrum measurement method is performed is equal to or more than a predetermined value.

### Supplementary Note 24

A program causing a computer of a spectrum measurement device to execute:

a process of outputting a first measurement result that is a result of measuring characteristics of light from an object to be measured;

a process of outputting a second measurement result that is a result of measuring intensity of light from the object to be measured;

a process of correcting the first measurement result, based on the second measurement result; and

a process of outputting a third measurement result, based on the corrected first measurement result.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

### INDUSTRIAL APPLICABILITY

The present invention is applicable to spectrum measurement under an environment in which intensity of incident light fluctuates.

### REFERENCE SIGNS LIST

10 Spectrum measurement system
100, 200 Spectrum measurement device
110 Spectroscope
111 Semitransparent mirror
112 Fixed mirror
113 Movable mirror
114 Optical detector
120, 220 Optical monitor
130, 230 Control circuit
210 Two-dimensional spectroscope
214 Two-dimensional optical detector
240 Optical splitter
250 Optical shutter
500 Object to be measured

What is claimed is:

1. A spectrum measurement device comprising:
a spectroscope configured to output a first measurement result that is a result of measuring characteristics of light from an object to be measured;
an optical monitor configured to output a second measurement result that is a result of measuring intensity fluctuation of light from the object to be measured; and
a control circuit configured to correct the first measurement result, based on the second measurement result and output a third measurement result, based on the corrected first measurement result.

2. The spectrum measurement device according to claim 1, wherein
the control circuit normalizes intensity of light included in the first measurement result during a measurement period of the spectroscope, based on a maximum value of intensity of light from the object to be measured during the measurement period of the spectroscope.

3. (canceled)

4. The spectrum measurement device according to claim 1, wherein
the first measurement result is a result of measurement measuring characteristics of light incident from the object to be measured with first spatial resolution, and
the second measurement result is a result of measurement measuring intensity of light incident from the object to be measured with second spatial resolution.

5. The spectrum measurement device according to claim 4, wherein
the first spatial resolution and the second spatial resolution are equal to each other.

6. The spectrum measurement device according to claim 4, wherein
the first spatial resolution is higher than the second spatial resolution.

7. The spectrum measurement device according to claim 1, wherein
the control circuit outputs the second measurement result as the third measurement result when fluctuation of the first measurement result during a predetermined period is within a predetermined fluctuation width.

8. The spectrum measurement device according to claim 1, wherein
the control circuit outputs one of the third measurement result selected from among the plurality of the third measurement results, based on spectral intensity in a predetermined wavelength range.

9. The spectrum measurement device according to claim 8, wherein
the predetermined wavelength range is a wavelength range on a short wavelength side within a wavelength range of the third measurement result.

10. The spectrum measurement device according to claim 8, wherein
the predetermined wavelength range is a wavelength range where scattering cross-section of scattering occurring between the object to be measured and the spectrum measurement device is equal to or more than a predetermined value.

11. The spectrum measurement device according to claim 1, wherein
the optical monitor is a photoelectric conversion device capable of two-dimensional imaging and the spectroscope is a two-dimensional Fourier spectroscope.

12. The spectrum measurement device according to claim 1, wherein
the optical monitor is a single-pixel photoelectric conversion device and the spectroscope is a two-dimensional Fourier spectroscope.

13. The spectrum measurement device according to claim 1, wherein
the optical monitor is connected to an output of an optical splitter that splits a portion of light from the object to be measured to the output at an intensity ratio of 1 percent or more and 20 percent or less.

14. A spectrum measurement method comprising:
outputting a first measurement result that is a result of measuring characteristics of light from an object to be measured;
outputting a second measurement result that is a result of measuring intensity of light from the object to be measured;
correcting the first measurement result, based on the second measurement result; and
outputting a third measurement result, based on the corrected first measurement result.

15-16. (canceled)

17. The spectrum measurement method according to claim 14, wherein
the first measurement result is a result of measurement measuring a spectrum of light from the object to be measured with first spatial resolution, and
the second measurement result is a result of measurement measuring intensity of light from the object to be measured with second spatial resolution.

18. The spectrum measurement method according to claim 17, wherein
the first spatial resolution and the second spatial resolution are equal to each other.

19. The spectrum measurement method according to claim 17, wherein
the first spatial resolution is higher than the second spatial resolution.

20. The spectrum measurement method according to claim 14, wherein
the method outputs the second measurement result as the third measurement result when fluctuation of the first measurement result during a predetermined period is within a predetermined fluctuation width.

21. The spectrum measurement method according to claim 14, wherein
the method outputs one of the third measurement result selected from among the plurality of the third measurement results, based on spectral intensity in a predetermined wavelength range.

22. The spectrum measurement method according to claim 21, wherein
the predetermined wavelength range is a wavelength range on a short wavelength side within a wavelength range of the third measurement result.

23. The spectrum measurement method according to claim 21, wherein
the predetermined wavelength range is a wavelength range where scattering cross-section of scattering occurring between an object to be measured and a position at which the spectrum measurement method is performed is equal to or more than a predetermined value.

24. (canceled)
